(19) United States
(12) Patent Application Publication
(10) Pub. No.: US 2019/0016078 A1
(43) Pub. Date: Jan. 17, 2019

(54) SELF-HEALING TIRE

(71) Applicant: Ghing-Hsin DIEN, Taipei City (TW)

(72) Inventor: Ghing-Hsin DIEN, Taipei City (TW)

(21) Appl. No.: 16/032,525

(22) Filed: Jul. 11, 2018

(30) Foreign Application Priority Data
Jul. 17, 2017 (TW) 106123816

(51) Int. Cl. B29D 30/06; B60C 19/12

(52) U.S. Cl. CPC B29D 30/0685; B29L 2030/008; B60C 19/12

(57) ABSTRACT

A self-healing pneumatic tire, which uses the sealant stored in the tire to fix a leak, is disclosed.

### CROSS REFERENCE TO RELATED APPLICATIONS

This Non-provisional application claims priority under 35 U.S.C. § 119(a) on Patent Application No(s). 106123816 filed in Taiwan, Republic of China on Jul. 17, 2017, the entire contents of which are hereby incorporated by reference.

### BACKGROUND

### Technology Field

The present disclosure relates to a tire having a self-healing function and, in particular, to a pneumatic tire that can seal a hole with the sealant stored in the tire.

### Description of Related Art

In the conventional self-healing tires, a layer of viscous sealant is usually coated on the inner layer of the pneumatic tire, or a closed sealant layer is provided on the inner surface of the tire tread. When the tire is punctured and leaving a hole passing through the sealant layer, the sealant will flow through the hole and fill the hole to prevent the tire from leaking. The disadvantage of these types of self-healing tires is that after the sealant seals the hole, the sealant cannot be refilled. In addition, the excess sealant cannot be recycled and reused, and most of these self-healing tires must be made in the tire factory, so the manufacturing cost is high.

Therefore, it is desired to provide a self-healing tire that can be manufactured with a lower cost. In addition, it is also desired not to manufacture the self-healing tire with any special process in the tire factory. Moreover, the self-healing tire can be acquired by retrofitting a conventional pneumatic tire. If the self-healing tire is punctured, the punctured hole can be repaired with the existing tire repairing technique, and the sealant can be recycled and/or refilled. Accordingly, the manufacturing cost of the self-healing tire of this disclosure is significantly reduced, and the installation and repair of the self-healing tire can be much easier. These advantages of this disclosure will make the self-healing tire become more available and popular.

### SUMMARY

In view of the foregoing, an objective of this disclosure is to provide a self-healing tire that can be easily retrofitted from a pneumatic tire and can be repaired, thereby reducing the manufacturing and maintenance costs of the self-healing tire.

In one embodiment, as shown in FIG. 1, a self-healing tire of this disclosure comprises a rim, a tire, an inner tube, and a sealant layer. The tire is airtightly connected to the rim. The inner tube can be inflated. The sealant layer is disposed between the tire and the inner tube. The liquid sealant can be injected into the sealant layer between the tire and inner tube through a valve stem. The inner tube can be inflated through a valve stem. The sealant will be pressed by the inflated inner tube and uniformly distributed in the sealant layer at the inner surface of the tire. The liquid pressure of the liquid sealant is equal to the air pressure inside the inner tube. If the tire is punctured, the sealant can be pressed by the inner tube and flow through the punctured hole. Then, the outflow sealant contacts the air and will seal the hole. If the tire and the inner tube are both punctured, the sealant will flow to the punctured holes due to the lower air pressure caused by the leakage. Accordingly, the sealant can seal the punctured holes and stop the air leaking.

In another embodiment, as shown in FIG. 2, another self-healing tire of this disclosure is similar to the above mentioned embodiment and further comprises a partition structure disposed between the tire and the inner tube for defining a space between the tire and the inner tube, which is used as the sealant layer. The sealant can be stored and flow inside the sealant layer. Accordingly, the sealant can be uniformly distributed on the desired part of the inner surface of the tire or the desired outer surface of the inner tube that is to be protected. The partition structure can be an independent structure or can be attached on the outer surface of the inner tube or the inner surface of the tire.

In another embodiment, as shown in FIG. 3, another self-healing tire of this disclosure is similar to the above mentioned embodiment but the valve stems of the tire and the inner tube are combined into a two-in-one valve stem protruding from a nozzle hole of the rim. An embodiment of the two-in-one valve stem includes two valves and two channels. One of the valves and one of the channels are used to inflate the inner tube, and the other valve and the other channel are used to inject sealant into the sealant layer between the tire and the inner tube. Alternatively, another embodiment of the two-in-one valve stem includes a common valve, two channels and a channel selection switch, so that the channel of the two-in-one valve stem becomes selectable. In other words, it is possible to switch the channel selection switch to select the desired operation, such as to inflate the inner tube or to inject the sealant into the sealant layer between the tire and the inner tube. The two-in-one valve stem of this embodiment is suitable for those rims which has only one nozzle hole, and so that a conventional tire without inner tube can be retrofitted into a self-healing tire of this disclosure.

As mentioned above, this disclosure is to dispose an inner tube inside a pneumatic tire, which is originally configured without any inner tube, and to inject the sealant into the space between the tire and the inner tube, thereby forming a self-healing tire. The self-healing tire of this disclosure has a lower installation cost and can be easily repaired. In addition, the self-healing tire can be acquired by retrofitting an existing conventional pneumatic tire. If the self-healing tire is punctured, the tire or the inner tube can be uninstalled and repaired with the existing repairing technique. Besides, the sealant inside the tire can be refilled or recycled through the nozzle(s). Accordingly, compared with other self-healing tires, the manufacturing cost of the self-healing tire of this disclosure can be sufficiently reduced, the repair of the self-healing tire can be much easier, and the self-healing tire of this disclosure can be acquired by retrofitting an existing conventional tire.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing a first embodiment of this disclosure;

FIG. 2 is a schematic diagram showing a second embodiment of this disclosure;

FIG. 3 is a schematic diagram showing a third embodiment of this disclosure;

FIG. 4 is a schematic diagram showing a two-in-one valve stem of this disclosure; and

FIG. 5 is a schematic diagram showing another two-in-one valve stem of this disclosure.

### DETAILED DESCRIPTION OF THE DISCLOSURE

The present disclosure will be apparent from the following detailed description, which proceeds with reference to the accompanying drawings, wherein the same references relate to the same elements.

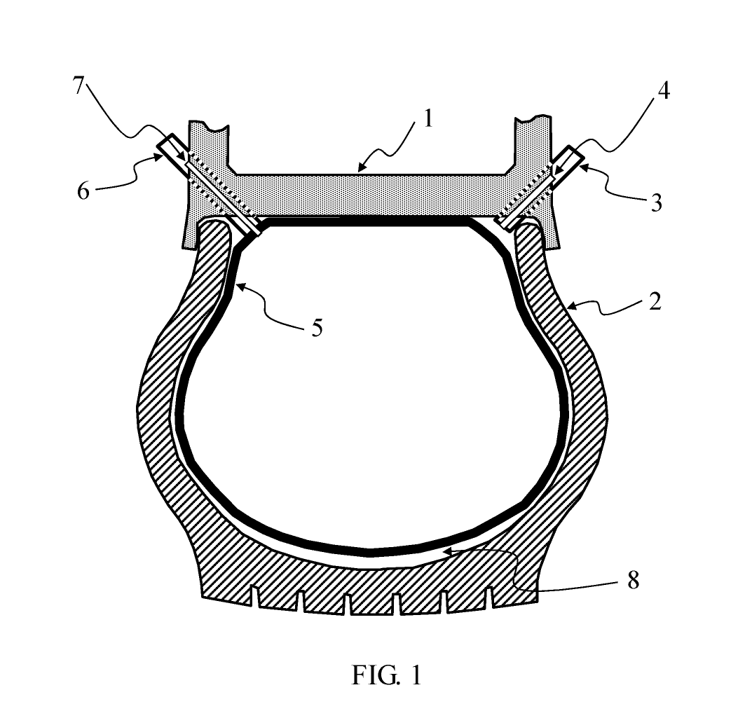

Referring to FIG. 1, a self-healing tire according to a first embodiment of this disclosure comprises a rim 1, an airtight tire 2, a tire valve stem (a first nozzle) 3, a tire channel 4, an inflatable inner tube 5, an inner tube valve stem (a second nozzle) 6, an inner tube channel 7, and a sealant layer 8 disposed between the tire and the inner tube. The rim 1 has a first nozzle hole and a second nozzle hole. The tire 2 is installed around the rim 1. The inner tube 5 is disposed between the rim 1 and the tire 2. The tire valve stem 3 protrudes from the first nozzle hole, and inner tube valve stem 6 protrudes from the second nozzle hole. The tire channel 4 is disposed inside the tire valve stem 3 and connects to the space between the tire 2 and the inner tube 5. The inner tube channel 7 is disposed inside the inner tube valve stem 6 and connects to the internal space of the inner tube 5. The tire valve stem 3 (the first nozzle) further contains a tire valve (not shown) for connecting to the tire channel 4, and the inner tube valve stem 6 (the second nozzle) further contains an inner tube valve (not shown) for connecting to the inner tube channel 7. The sealant layer 8 is configured for storing a sealant which is injected through the tire channel 4. After the inner tube 5 is inflated through the inner tube valve stem 6 and the inner tube channel 7, the sealant can be injected to the sealant layer 8 between the tire 2 and the inner tube 5 through the tire valve stem 3 and the tire channel 4. The sealant will be pressed by the air pressure of the inner tube 5 and uniformly distributed in the sealant layer 8 at the inner surface of the tire 2. The liquid pressure of liquid sealant is equal to the air pressure inside the inner tube 5. If the tire 2 is punctured, the sealant can be pressed by the inner tube and flow through the punctured hole. Then, the outflow sealant contacts the air and will seal the hole and prevent the leaking. If the tire 2 and the inner tube 5 are both punctured, the sealant will flow to the punctured holes due to the lower air pressure caused by the leakage. Accordingly, the sealant can seal the punctured holes and stop the air leaking.

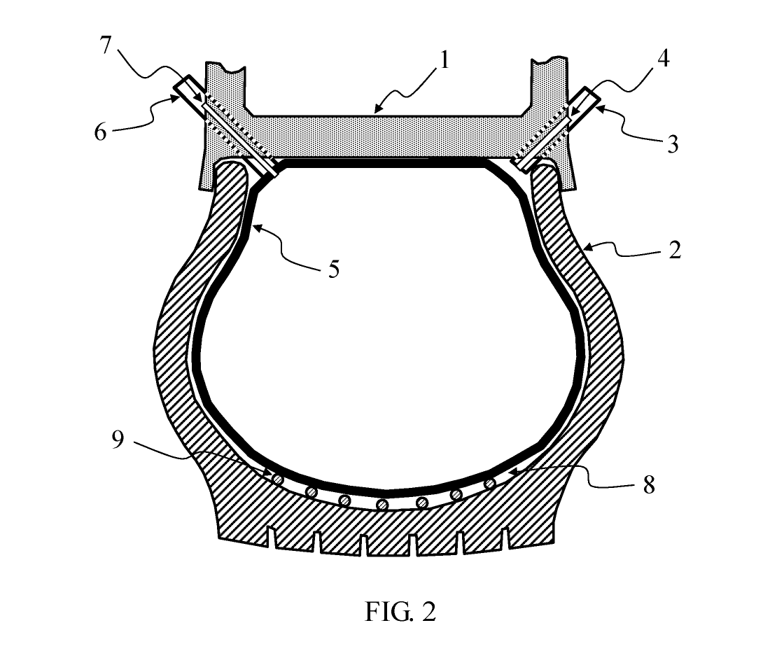

FIG. 2 shows a self-healing tire according to a second embodiment of this disclosure. The self-healing tire of FIG. 2 is similar to the self-healing tire of the first embodiment. Different from the self-healing tire of the first embodiment, the self-healing tire of FIG. 2 further comprises a partition structure 9 disposed between the tire 2 and the inner tube 5 for defining a space between the tire 2 and the inner tube 5, which is used as the sealant layer 8. The sealant can be stored and flow inside the sealant layer 8. Accordingly, the sealant can be uniformly distributed on the desired inner surface of the tire 2 that is to be protected or the outer surface of the inner tube 5 that is to be protected. The partition structure 9 has some protruding portions for controlling the distribution of the sealant inside the self-healing tire. The partition structure 9 can be attached on the outer surface of the inner tube 5 or on the inner surface of the tire 2, or it can be an independent structure installed, separated from the tire 2 and the inner tube 5.

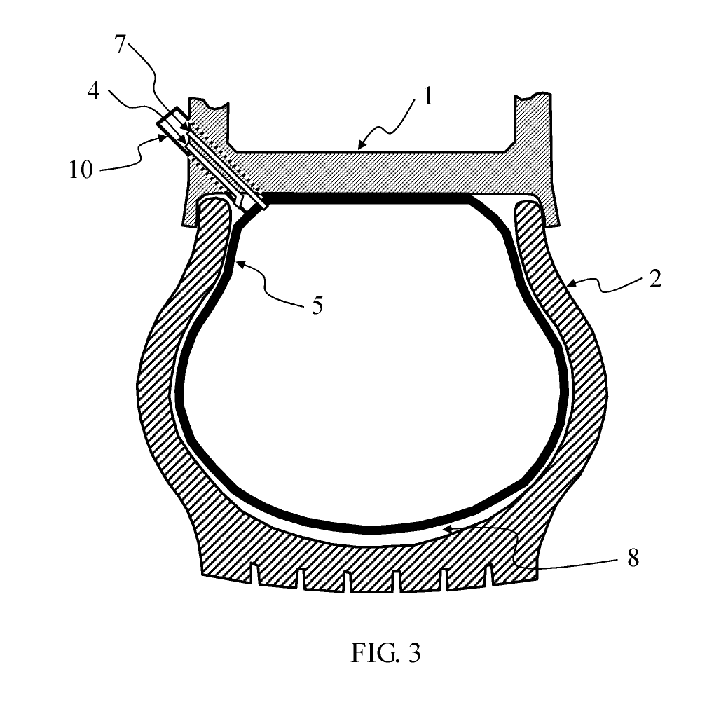

FIG. 3 shows a self-healing tire according to a third embodiment of this disclosure. The self-healing tire of FIG. 3 is similar to the self-healing tire of the first embodiment. Different from the self-healing tire of the first embodiment, in the self-healing tire of FIG. 3, the tire valve stem 3 and the inner tube valve stem 6 are combined into a two-in-one valve stem 10, which protrudes from a nozzle hole of the rim 1. As shown in FIG. 3, the two-in-one valve stem 10 passes through the hole (nozzle hole) of the rim 1. Therefore, the rim 1 only needs one nozzle hole for installing the two-in-one valve stem 10. The tire channel 4 and the inner tube channel 7 are both located inside the two-in-one valve stem 10. Herein, the inner tube channel 7 is connected with the inner space of the inner tube 5, and the tire channel 4 is connected with the inner space of the tire 2 (e.g. the space between the inner tube 5 and the tire 2). This embodiment only needs one valve stem for inflating the inner tube 5 and injecting the sealant into the sealant layer 8 between the tire 2 and the inner tube 5. The two-in-one valve stem 10 of this embodiment is suitable for most commercial rims 1, which have only one nozzle hole, and a conventional pneumatic tire without inner tube can be retrofitted into a self-healing tire of this disclosure.

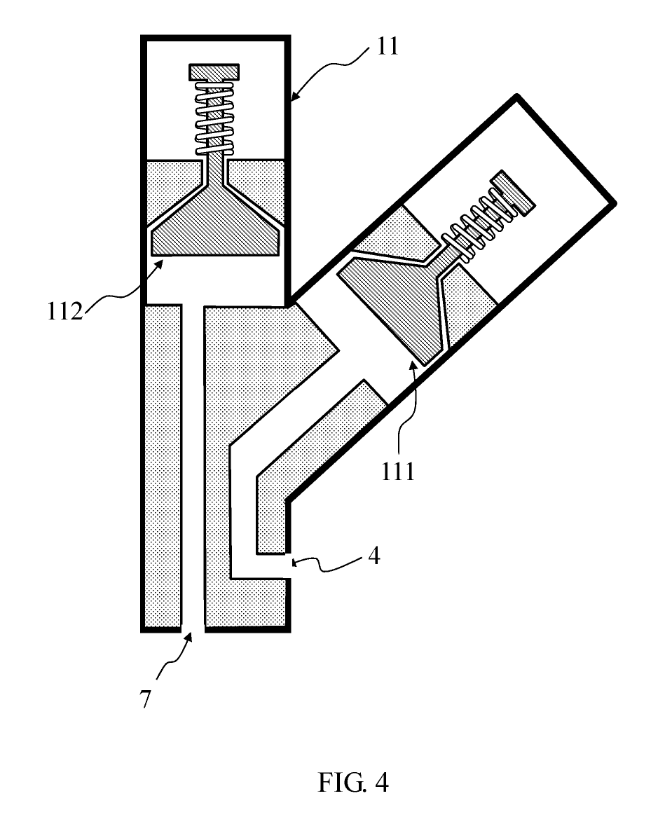

FIG. 4 shows an embodiment of the two-in-one valve stem. As shown in FIG. 4, the two-in-one valve stem 11 includes two valves (a tire valve 111 and an inner tube valve 112) and two channels (a tire channel 4 and an inner tube channel 7). The inner tube channel 7 is connected to the inner space of the inner tube 5, and the tire channel 4 is connected to the sealant layer 8 between the tire 2 and the inner tube 5. In this embodiment, the inner tube valve 112 and the inner tube channel 7 are used to inflate the inner tube 5, and the tire valve 111 and the tire channel 4 are used to inject sealant into the sealant layer 8 between the tire 2 and the inner tube 5. The two-in-one valve stem 11 of this embodiment is suitable for most commercial rims 1, which have only one nozzle hole, and a conventional pneumatic tire without inner tube can be retrofitted into a self-healing tire of this disclosure.

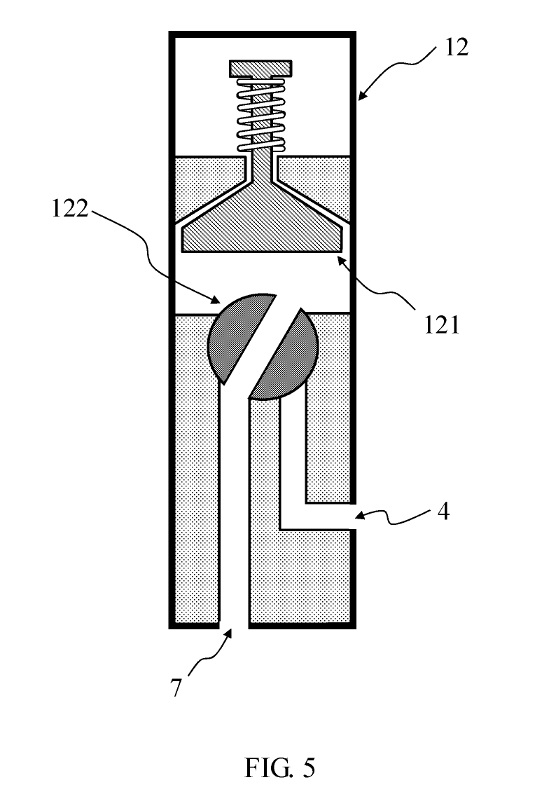

FIG. 5 shows another embodiment of the two-in-one valve stem. As shown in FIG. 5, the two-in-one valve stem 12 includes a common valve 121, two channels (a tire channel 4 and an inner tube channel 7), and a channel selection switch 122, so that the channel of the two-in-one valve stem 12 becomes selectable. The inner tube channel 7 is connected to the inner space of the inner tube 5, and the tire channel 4 is connected to the sealant layer 8 between the tire 2 and the inner tube 5. Accordingly, the channel selection switch 122 can be switched to connect the common valve 121 to either one of the tire channel 4 and the inner tube channel 7, thereby selecting the desired operation such as to inflate the inner tube 5 or to inject the sealant into the sealant layer 8 between the tire 2 and the inner tube 5. The two-in-one valve stem 12 of this embodiment is suitable for most commercial rims 1, which have only one nozzle hole, and a conventional pneumatic tire without inner tube can be retrofitted into a self-healing tire of this disclosure.

As mentioned above, this disclosure is to add an inner tube inside the pneumatic tire, which originally does not contain any inner tube, and to inject the sealant into the space between the tire and the inner tube through the tire channel. Thus, the manufacturing cost of the self-healing tire of this disclosure is significantly reduced, the repair of the self-healing tire is much easier, and the self-healing tire of this disclosure can be acquired by retrofitting an existing conventional tire.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A self-healing tire, comprising:
a rim having at least a nozzle hole;
a tire installed around the rim;
an inner tube disposed between the rim and the tire;
at least a valve stem protruding from the nozzle hole;
a tire channel disposed inside the valve stem and connecting to a space between the tire and the inner tube;
an inner tube channel disposed inside the valve stem and connecting to an internal space of the inner tube for inflating the inner tube; and
a sealant layer disposed between the tire and the inner tube for storing a sealant to be injected through the tire channel;
wherein the valve stem further comprises a tire valve and an inner tube valve, the tire valve is connected with the tire channel, and the inner tube valve is connected with the inner tube channel.

2. The self-healing tire according to claim 1, further comprising a partition structure for separating the tire and the inner tube and to form a space to accommodate the sealant so as to form the sealant layer, wherein the partition structure is disposed on an outer surface of the inner tube or on an inner surface of the tire, or between the tire and the inner tube.

3. A self-healing tire, comprising:
a rim having at least a nozzle hole;
a tire installed around the rim;
an inner tube disposed between the rim and the tire;
a valve stem protruding from the nozzle hole;
a tire channel disposed inside the valve stem and connecting to a space between the tire and the inner tube;
an inner tube channel disposed inside the valve stem and connecting to an internal space of the inner tube for inflating the inner tube; and
a sealant layer disposed between the tire and the inner tube for storing a sealant to be injected through the tire channel;
wherein the valve stem further comprises a common valve and a channel selection switch, the channel selection switch selectively controls the common valve to be connected with the inner tube channel or the tire channel.

4. The self-healing tire according to claim 3, further comprising a partition structure for separating the tire and the inner tube and to form a space to accommodate the sealant so as to form the sealant layer, wherein the partition structure is disposed on an outer surface of the inner tube or on an inner surface of the tire, or between the tire and the inner tube.

5. A self-healing tire, comprising:
a rim at least having a first nozzle hole and a second nozzle hole;
a tire installed around the rim;
an inner tube disposed between the rim and the tire;
a first valve stem and a second valve stem, wherein the first valve stem protrudes from the first nozzle hole, and the second valve stem protrudes from the second nozzle hole;
a tire channel disposed inside the first valve stem and connecting to a space between the tire and the inner tube;
an inner tube channel disposed inside the second valve stem and connecting to an internal space of the inner tube for inflating the inner tube; and
a sealant layer disposed between the tire and the inner tube for storing a sealant to be injected through the tire channel;
wherein the first valve stem further comprises a tire valve connected with the tire channel, and the second valve stem further comprises an inner tube valve connected with the inner tube channel.

6. The self-healing tire according to claim 5, further comprising a partition structure for separating the tire and the inner tube and to form a space to accommodate the sealant so as to form the sealant layer, wherein the partition structure is disposed on an outer surface of the inner tube or on an inner surface of the tire, or between the tire and the inner tube.
